(19) United States
(12) Patent Application Publication
(10) Pub. No.: US 2026/0348369 A1
(43) Pub. Date: Nov. 5, 2026

(54) SQUARE WAVE CONTROL FOR A SINGLE PHASE LINEAR COMPRESSOR

(71) Applicant: Haier US Appliance Solutions, Inc., Wilmington, DE (US)

(72) Inventors: Joseph Wilson Latham, Louisville, KY (US); Thomas Raymond Everson, Louisville, KY (US)

(21) Appl. No.: 19/075,970

(22) Filed: Mar. 11, 2025

(51) Int. Cl. F04B 35/04; F25B 31/02; F25D 11/00; H02K 33/18; H02P 21/22; H02P 25/034

(52) U.S. Cl. CPC F04B 35/04; F25B 31/023; F25D 11/00; H02K 33/18; H02P 21/22; H02P 25/034; F25B 2600/024

(57) ABSTRACT

A method for controlling a linear compressor of an appliance is provided. The method includes operating a motor of the linear compressor in order to drive a rotor of the motor. The method also includes obtaining, via a controller of the linear compressor, one or more voltage components of a voltage reference signal. Further, the method includes determining, via the controller, a modified square wave based, at least in part, on the one or more voltage components. In addition, the method includes controlling, via the controller, the motor based on the modified square wave.

### FIELD

Example aspects of the present disclosure relate to linear compressors, such as linear compressors for refrigerators and other appliances.

### BACKGROUND

Generally, refrigerator appliances include a cabinet that defines one or more chilled chambers, such as a fresh food chamber for receipt of food items for storage and/or a freezer chamber for receipt of food items for freezing and storage. Certain refrigerator appliances may also include sealed systems for cooling such chilled chambers thereof. The sealed systems generally include a linear compressor that generates compressed refrigerant during operation thereof. The compressed refrigerant flows to an evaporator where heat exchanges between the chilled chambers and the refrigerant cools the chilled chambers and food items located therein.

Linear compressors generally include a piston within a housing and a driving coil that generates a force for moving the piston forward and backward within the housing. During motion of the piston within the housing, the piston compresses the refrigerant. Furthermore, linear compressors are generally operated a single-phase motor driven by a single-phase variable-frequency drive. The variable-frequency drive is a type of motor drive that is used to control the motor speed and force by varying motor voltage input frequency and amplitude.

### SUMMARY

Aspects and advantages of embodiments of the present disclosure will be set forth in part in the following description, or can be learned from the description, or can be learned through practice of the embodiments.

In one exemplary aspect of the present disclosure, a method for controlling a linear compressor of an appliance is provided. The method includes operating a motor of the linear compressor in order to drive a rotor of the motor. The method also includes obtaining, via a controller of the linear compressor, one or more voltage components of a voltage reference signal. Further, the method includes determining, via the controller, a modified square wave based, at least in part, on the one or more voltage components. In addition, the method includes controlling, via the controller, the motor based on the modified square wave.

In one exemplary aspect of the present disclosure, a linear compressor defining an axial direction and a vertical direction is provided. The linear compressor includes a cylindrical casing defining a compressor chamber. The linear compressor also includes a piston positioned within the compressor chamber and being movable along the axial direction. Further, the linear compressor includes a motor operably coupled to the piston. In addition, the linear compressor includes an controller configured to supply a modified square wave to the motor. The controller is configured to perform operations. The operations include obtaining one or more voltage components of a voltage reference signal. The operations also include determining a modified square wave based, at least in part, on the one or more voltage components. In addition, the operations include controlling the motor based on the modified square wave.

In one exemplary aspect of the present disclosure, an appliance is provided. The appliance includes a cabinet defining an internal chamber. The appliance also includes a door mounted to the cabinet to provide selective access to the internal chamber. Further, the appliance includes a linear compressor. The linear compressor includes a piston movable in a negative axial direction toward a compressor chamber and a positive axial direction away from the compressor chamber. Furthermore, the appliance includes a motor operably coupled to the piston. In addition, the appliance includes a controller configured to supply a variable frequency waveform to the motor. The controller is configured to perform operations. The operations include obtaining one or more voltage components of a voltage reference signal. The operations also include determining a modified square wave based, at least in part, on the one or more voltage components. In addition, the operations include controlling the motor based on the modified square wave.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a front elevation view of a refrigerator appliance according to example embodiments of the present disclosure;

FIG. 2 depicts a schematic view of certain components of the example refrigerator appliance of FIG. 1 according to example embodiments of the present disclosure;

FIG. 3 depicts a perspective, section view of a linear compressor according to an exemplary embodiment of the present disclosure;

FIG. 4 depicts another perspective, section view of the exemplary linear compressor of FIG. 3 according to an embodiment of the present disclosure;

FIG. 5 depicts a perspective view of a linear compressor with a compressor housing removed for clarity according to an example embodiment of the present disclosure;

FIG. 6 depicts a section view of the exemplary linear compressor of FIG. 3 with a piston in an extended position according to an embodiment of the present disclosure;

FIG. 7 depicts a section view of the exemplary linear compressor of FIG. 3 with the piston in a retracted position according to an embodiment of the present disclosure;

FIG. 8 depicts a block diagram of one embodiment of a controller of a refrigerator appliance according to example embodiments of the present disclosure;

FIG. 9 depicts an example method for operating a linear compressor according to example embodiments of the present disclosure;

FIG. 10 depicts an example control scheme operable to control a linear compressor according to example embodiments of the present disclosure;

FIG. 11 depicts an example single-phase vector-like control scheme implemented by the controller of FIG. 10 according to example embodiments of the present disclosure;

FIG. 12 depicts a control diagram of an example embodiment of a square wave generation module from the control scheme of FIG. 11 according to one or more example embodiments of the present disclosure;

FIG. 13 depicts a plot of a modified square wave configured to achieve a reference voltage signal according to one or more example embodiments of the present disclosure; and

FIG. 14 illustrates correlated plots of testing results of a controller implementing a modified square wave to control a motor of the linear compressor according to one or more additional example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure relate generally to linear compressors such as, e.g., linear compressors for refrigerators and other appliances.

Linear compressors often require complex control algorithms to control motion of the piston. For instance, motion of the piston may be controlled such that the piston does not impact a cylinder head of the linear compressor. Further, motion of the piston may be controlled to adjust a cooling capacity of the linear compressor (e.g., by adjusting the piston stroke length, a linear velocity of the piston, and a minimum clearance between the piston and the cylinder head). In addition, the motion of the piston may be further controlled to oscillate at a mechanical resonant frequency, which is dependent on a load, so as to maximize performance. The motion of the piston may be controlled by varying a voltage applied to the linear compressor.

To achieve optimal control of the linear compressor, the voltage (e.g., an amplitude, a phase, a frequency, and/or a DC offset) must be manipulated. Typically, voltage modulation is performed by a voltage source inverter, which can produce switching waveforms from a DC supply voltage according to various modulation schemes. However, the use of inverters introduces additional power losses to the linear compressor due to both switching and conduction losses in the inverter, each of which are influenced by the selected inverter modulation scheme. Furthermore, the selected inverter modulation scheme affects conduction losses in the motor of the linear compressor through the harmonic content of the induced motor current. Accordingly, an inverter modulation scheme that balances losses of both the inverter and the motor is desired.

According to example aspects of the present disclosure, an appliance (e.g., a refrigerator appliance) can include a single-phase linear compressor driven by a single-phase linear motor. A controller controls the motor using a modified square wave so as to minimize switching and conduction losses of the coupled inverter-linear compressor system.

The systems and methods according to example embodiments of the present disclosure provide a number of technical effects and benefits. For instance, example aspects of the present disclosure provide a system and method for controlling a motor of a linear compressor based on a modified square wave. This is achieved by determining the modified square wave based, at least in part, on one or more voltage components (e.g., DC, d-axis, and q-axis components), as will be discussed in more detail below. In this way, the modified square wave can have the same ac amplitude and phase of the voltage components as a sinusoidal reference voltage signal. Controlling the motor based on the modified square wave allows for the inverter to implement four transitions per cycle, which can reduce switching losses for the inverter. Further, conduction losses introduced by the modified square wave are minimized by an inductance of the stator of the motor. As such, the conduction losses are outweighed by the reduction in the inverter losses, which results in improved efficiency of the linear compressor.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

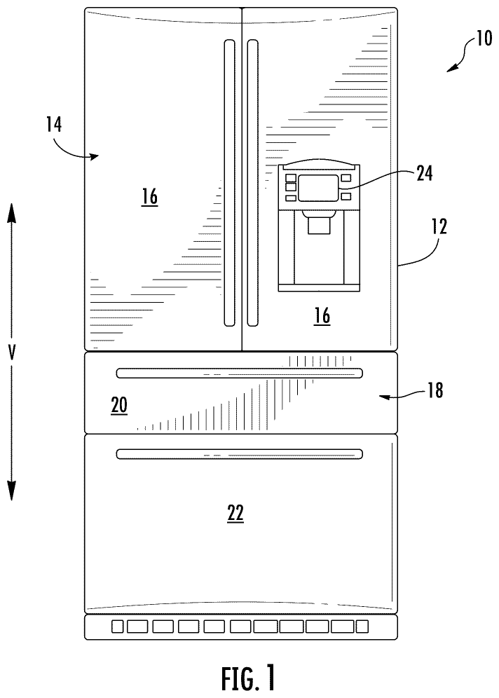

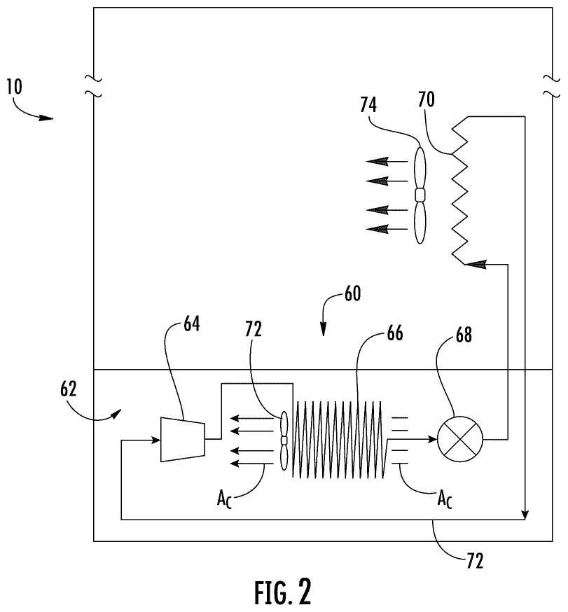

FIG. 1 depicts a refrigerator appliance 10 that incorporates a sealed refrigeration system 60 (FIG. 2). It should be appreciated that the term “refrigerator appliance” is used in a generic sense herein to encompass any manner of refrigeration appliance, such as a freezer, refrigerator/freezer combination, and any style or model of conventional refrigerator. In addition, it should be understood that the present subject matter is not limited to use in refrigerator appliances. Thus, the present subject matter may be used for any other suitable purpose, such as vapor compression within air conditioning units or air compression within air compressors.

In the illustrated example embodiment shown in FIG. 1, the refrigerator appliance 10 is depicted as an upright refrigerator having a cabinet 12 that defines a number of internal chilled storage compartments. In particular, refrigerator appliance 10 includes upper fresh-food compartments 14 having doors 16 and lower freezer compartment 18 having upper drawer 20 and lower drawer 22. The drawers 20 and 22 are “pull-out” drawers in that they can be manually moved into and out of the freezer compartment 18 on suitable slide mechanisms. Due to the doors 16 being rotatably mounted to the cabinet 12, the doors 16 provide selective access to the internal chamber. As used herein, “internal chamber” refers to the internal chilled storage compartments defined by the cabinet 12.

FIG. 2 is a schematic view of certain components of refrigerator appliance 10, including a sealed refrigeration system 60 of refrigerator appliance 10. A machinery compartment 62 contains components for executing a known vapor compression cycle for cooling air. The components include a compressor 64, a condenser 66, an expansion device 68, and an evaporator 70 connected in series by fluid conduit 72 that is charged with a refrigerant. As will be understood by those skilled in the art, refrigeration system 60 may include additional components, e.g., at least one additional evaporator, compressor, expansion device, and/or condenser. As an example, refrigeration system 60 may include two evaporators.

Within refrigeration system 60, refrigerant flows into compressor 64, which operates to increase the pressure of the refrigerant. This compression of the refrigerant raises its temperature, which is lowered by passing the refrigerant through condenser 66. Within condenser 66, heat exchange with ambient air takes place so as to cool the refrigerant. A fan 74 is used to pull air across condenser 66, as illustrated by arrows A_{C}, so as to provide forced convection for a more rapid and efficient heat exchange between the refrigerant within condenser 66 and the ambient air. Thus, as will be understood by those skilled in the art, increasing air flow across condenser 66 can, e.g., increase the efficiency of condenser 66 by improving cooling of the refrigerant contained therein.

An expansion device 68 (e.g., a valve, capillary tube, or other restriction device) receives refrigerant from condenser 66. From expansion device 68, the refrigerant enters evaporator 70. Upon exiting expansion device 68 and entering evaporator 70, the refrigerant drops in pressure. Due to the pressure drop and/or phase change of the refrigerant, evaporator 70 is cool relative to compartments 14 and 18 of refrigerator appliance 10. As such, cooled air is produced and refrigerates compartments 14 and 18 of refrigerator appliance 10. Thus, evaporator 70 is a type of heat exchanger which transfers heat from air passing over evaporator 70 to refrigerant flowing through evaporator 70.

Collectively, the vapor compression cycle components in a refrigeration circuit, associated fans, and associated compartments are sometimes referred to as a sealed refrigeration system operable to force cold air through compartments 14, 18 (FIG. 1). The refrigeration system 60 depicted in FIG. 2 is provided by way of example only. Thus, it is within the scope of the present subject matter for other configurations of the refrigeration system to be used as well.

As described above, sealed refrigeration system 60 performs a vapor compression cycle to refrigerate compartments 14, 18 of refrigerator appliance 10. However, as is understood in the art, refrigeration system 60 is a sealed system that may be alternately operated as a refrigeration assembly (and thus perform a refrigeration cycle as described above) or a heat pump (and thus perform a heat pump cycle). Thus, for example, aspects of the present subject matter may similarly be used in a sealed system for an air conditioner unit, e.g., to perform by a refrigeration or cooling cycle and a heat pump or heating cycle. In this regard, when a sealed system is operating in a cooling mode and thus performs a refrigeration cycle, an indoor heat exchanger acts as an evaporator and an outdoor heat exchanger acts as a condenser. Alternatively, when the sealed system is operating in a heating mode and thus performs a heat pump cycle, the indoor heat exchanger acts as a condenser and the outdoor heat exchanger acts as an evaporator.

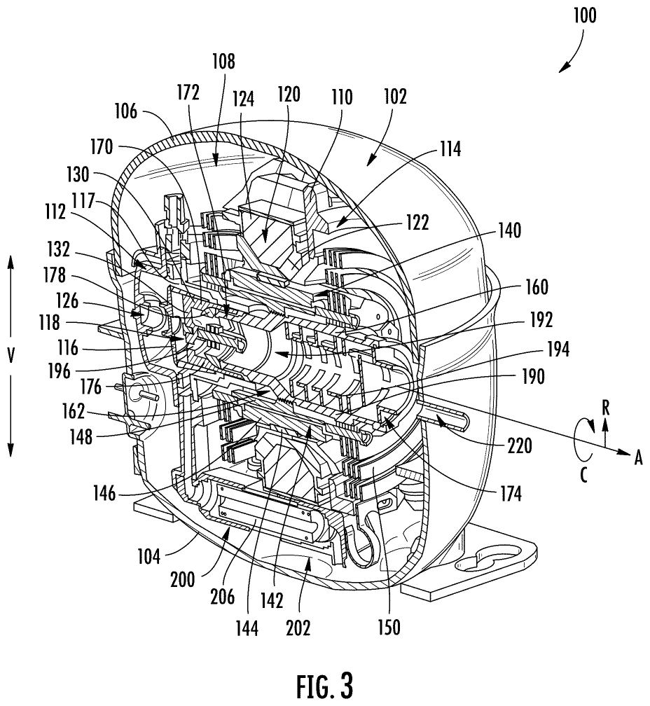

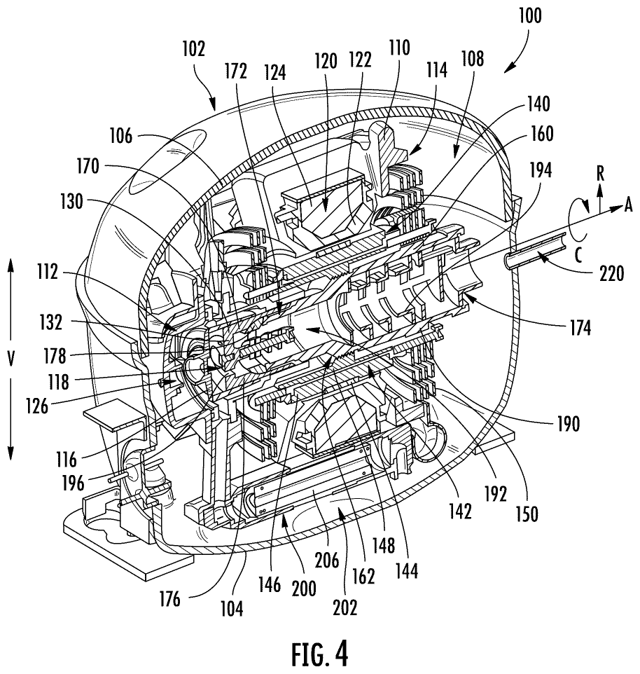

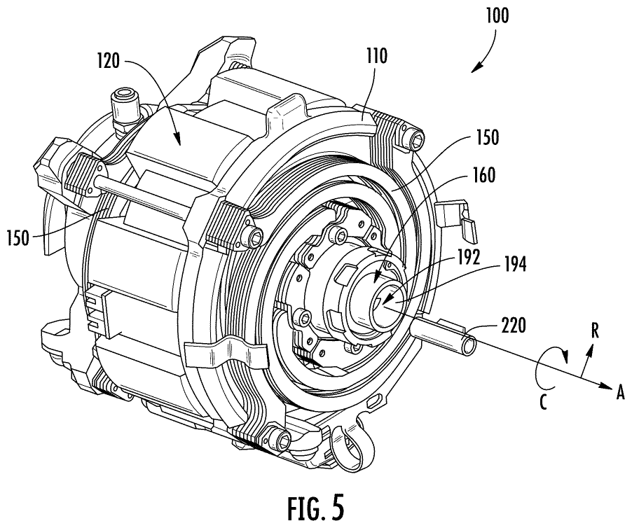

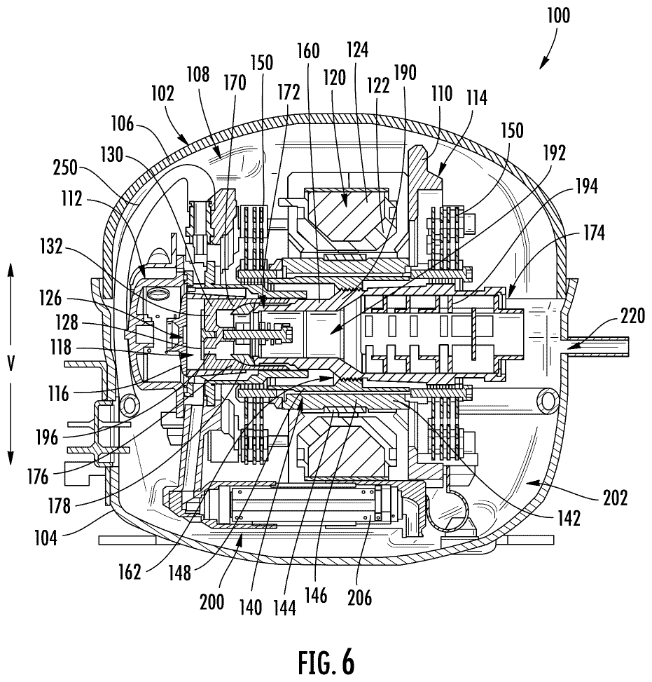

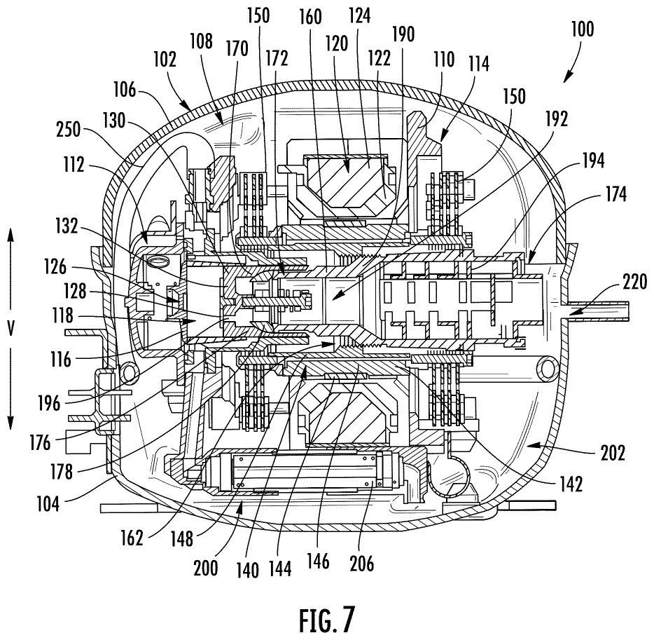

Referring now generally to FIGS. 3 through 7, a linear compressor 100 is described according to exemplary embodiments of the present subject matter. Specifically, FIGS. 3 and 4 provide perspective, section views of the linear compressor 100, FIG. 5 provides a perspective view of the linear compressor 100 with a compressor shell or housing 102 removed for clarity, and FIGS. 6 and 7 provide section views of the linear compressor when a piston thereof is in extended and retracted positions, respectively. It should be appreciated that the linear compressor 100 is used herein only as an exemplary embodiment to facilitate the description of aspects of the present subject matter. Modifications and variations may be made to the linear compressor 100 while remaining within the scope of the present subject matter.

As illustrated for example in FIGS. 3 and 4, the housing 102 may include a lower portion or lower housing 104 and an upper portion or upper housing 106 which are joined together to form a substantially enclosed cavity 108 for housing various components of linear compressor 100. Specifically, for example, cavity 108 may be a hermetic or air-tight shell that can house working components of linear compressor 100 and may hinder or prevent refrigerant from leaking or escaping from refrigeration system 60. In addition, linear compressor 100 generally defines an axial direction A, a radial direction R, and a circumferential direction C. It should be appreciated that linear compressor 100 is described and illustrated herein only to describe aspects of the present subject matter. Variations and modifications to linear compressor 100 may be made while remaining within the scope of the present subject matter.

Referring particularly to FIGS. 3 through 7, various parts and working components of the linear compressor 100 will be described according to an exemplary embodiment. As shown, the linear compressor 100 includes a casing 110 that extends between a first end portion 112 and a second end portion 114, e.g., along the axial direction A. The casing 110 includes a cylinder 117 that defines a compressor chamber 118. The cylinder 117 is positioned at or adjacent first end portion 112 of casing 110. The chamber 118 extends longitudinally along the axial direction A. As discussed in greater detail below, the linear compressor 100 is operable to increase a pressure of fluid within chamber 118 of linear compressor 100. Further, the linear compressor 100 may be used to compress any suitable fluid, such as refrigerant or air. In particular, the linear compressor 100 may be used in a refrigerator appliance, such as refrigerator appliance 10 (FIG. 1) in which the linear compressor 100 may be used as compressor 64 (FIG. 2).

Moreover, as shown, the linear compressor 100 includes a stator 120 of a motor that is mounted or secured to casing 110. For example, stator 120 generally includes an outer back iron 122 and a driving coil 124 that extend about the circumferential direction C within casing 110. The linear compressor 100 also includes one or more valves that permit refrigerant to enter and exit chamber 118 during operation of linear compressor 100. For example, a discharge muffler 126 is positioned at an end of chamber 118 for regulating the flow of refrigerant out of chamber 118, while a suction valve 128 (shown only in FIGS. 6-7 for clarity) regulates flow of refrigerant into chamber 118.

A piston 130 with a piston head 132 is slidably received within chamber 118 of cylinder 117. The piston 130 can be operably coupled to the motor. In particular, piston 130 is movable along the axial direction A. For instance, the piston 130 can be movable in a negative axial direction A toward the chamber 118. The piston 130 can be movable in a positive axial direction A away from the chamber 118. During sliding of piston head 132 within chamber 118, piston head 132 compresses refrigerant within chamber 118. As an example, from a top dead center position (see, e.g., FIG. 6), piston head 132 can slide within chamber 118 towards a bottom dead center position (see, e.g., FIG. 7) along the axial direction A, i.e., an expansion stroke of piston head 132. When piston head 132 reaches the bottom dead center position, piston head 132 changes directions and slides in chamber 118 back towards the top dead center position, i.e., a compression stroke of piston head 132. It should be understood that the linear compressor 100 may include an additional piston head and/or additional chambers at an opposite end of linear compressor 100. Thus, linear compressor 100 may have multiple piston heads in alternative exemplary embodiments.

As illustrated, the linear compressor 100 also includes a mover 140 which is generally driven by stator 120 for compressing refrigerant. Specifically, for example, mover 140 may include an inner back iron 142 positioned in stator 120 of the motor. In particular, outer back iron 122 and/or driving coil 124 may extend about inner back iron 142, e.g., along the circumferential direction C. Inner back iron 142 also has an outer surface that faces towards outer back iron 122 and/or driving coil 124. At least one driving magnet 144 is mounted to inner back iron 142, e.g., at the outer surface of inner back iron 142.

Driving magnet 144 may face and/or be exposed to driving coil 124. In particular, driving magnet 144 may be spaced apart from driving coil 124, e.g., along the radial direction R by an air gap. Thus, the air gap may be defined between opposing surfaces of driving magnet 144 and driving coil 124. Driving magnet 144 may also be mounted or fixed to inner back iron 142 such that an outer surface of driving magnet 144 is substantially flush with the outer surface of inner back iron 142. Thus, driving magnet 144 may be inset within inner back iron 142. In such a manner, the magnetic field from driving coil 124 may have to pass through only a single air gap between outer back iron 122 and inner back iron 142 during operation of the linear compressor 100, and the linear compressor 100 may be more efficient relative to linear compressors with air gaps on both sides of a driving magnet.

As may be seen in FIG. 3, the driving coil 124 extends about inner back iron 142, e.g., along the circumferential direction C. In alternative example embodiments, inner back iron 142 may extend around driving coil 124 along the circumferential direction C. The driving coil 124 is operable to move the inner back iron 142 along the axial direction A during operation of driving coil 124. As an example, a current may be induced within driving coil 124 by a current source (not shown) to generate a magnetic field that engages driving magnet 144 and urges piston 130 to move along the axial direction A in order to compress refrigerant within chamber 118 as described above and will be understood by those skilled in the art. In particular, the magnetic field of driving coil 124 may engage driving magnet 144 in order to move inner back iron 142 and piston head 132 along the axial direction A during operation of driving coil 124. Thus, the driving coil 124 may slide the piston 130 between the top dead center position and the bottom dead center position, e.g., by moving inner back iron 142 along the axial direction A, during operation of driving coil 124.

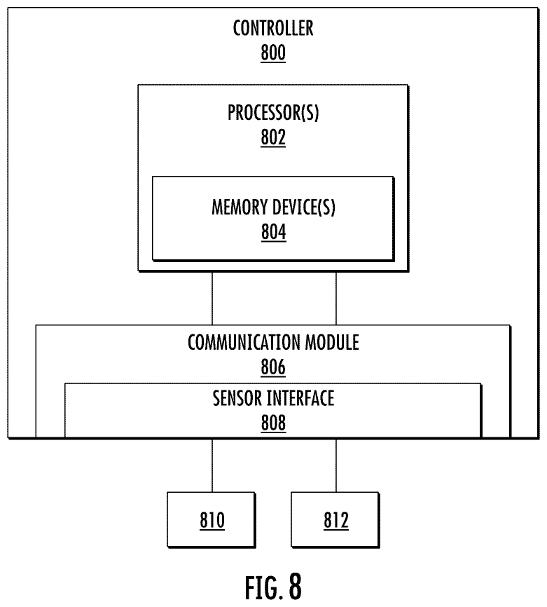

Referring particularly to FIG. 8, operation of the refrigerator appliance 10 may generally be controlled by a processing device or controller 800. The controller 800 may, for example, be operatively coupled to the control panel 24 for user manipulation to select features and operations of the refrigerator appliance 10, such as temperature set points. Thus, the controller 800 can operate various components of the refrigerator appliance 10 to execute selected system cycles, processes, and/or features. In exemplary embodiments, the controller 800 is in operative communication (e.g., electrical or wireless communication) with each of the chambers or compartments therein, for example, to regulate temperature as described herein.

More specifically, as shown in FIG. 8, a block diagram of one embodiment of suitable components that may be included within the controller 800 in accordance with example aspects of the present disclosure is illustrated. As shown, the controller 800 may include one or more processor(s) 802, computer, or other suitable processing unit and associated memory device(s) 804 that may include suitable computer-readable instructions that, when implemented, configure the controller to perform various different functions, such as receiving, transmitting and/or executing signals (e.g., performing the methods, steps, calculations and the like disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 804 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. The memory can be a separate component from the processor or can be included onboard within the processor.

Such memory device(s) 804 may generally be configured to store suitable computer-readable instructions that, when implemented by the processor(s) 802, configure the controller to perform various functions as described herein. In particular, the processor(s) 802 can include microprocessors, CPUs or the like, such as general or special purpose microprocessors operable to execute programming instructions or micro-control code associated with operation of the linear compressor 100. Additionally, the controller 800 may also include a communications module 806 to facilitate communications between the controller and the various components of the refrigerator appliance 10. An interface can include one or more circuits, terminals, pins, contacts, conductors, or other components for sending and receiving control signals. Moreover, the controller 800 may include a sensor interface 808 (e.g., one or more analog-to-digital converters) to permit signals transmitted from the temperature probe(s) 810 to be converted into signals that can be understood and processed by the processor(s) 802. The controller 800 may furthermore optionally receive a second temperature signal(s) from the thermistor(s) 812 configured to generate one or more second temperature signals representative of the actual temperature of the item or the chamber.

Alternatively, the controller 800 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The inner back iron 142 further includes an outer cylinder 146 and an inner sleeve 148. The outer cylinder 146 defines the outer surface of inner back iron 142 and also has an inner surface positioned opposite the outer surface of outer cylinder 146. The inner sleeve 148 is positioned on or at inner surface of outer cylinder 146. A first interference fit between outer cylinder 146 and inner sleeve 148 may couple or secure outer cylinder 146 and inner sleeve 148 together. In alternative exemplary embodiments, inner sleeve 148 may be welded, glued, fastened, or connected via any other suitable mechanism or method to outer cylinder 146.

The outer cylinder 146 may be constructed of or with any suitable material. For example, outer cylinder 146 may be constructed of or with a plurality of (e.g., ferromagnetic) laminations. The laminations are distributed along the circumferential direction C in order to form outer cylinder 146 and are mounted to one another or secured together, e.g., with rings pressed onto ends of the laminations. The outer cylinder 146 may define a recess that extends inwardly from the outer surface of outer cylinder 146, e.g., along the radial direction R. The driving magnet 144 is positioned in the recess on outer cylinder 146, e.g., such that the driving magnet 144 is inset within outer cylinder 146.

The linear compressor 100 also includes a plurality of planar springs 150. Each planar spring 150 may be coupled to a respective end of inner back iron 142, e.g., along the axial direction A. During operation of driving coil 124, planar springs 150 support inner back iron 142. In particular, the inner back iron 142 is suspended by planar springs 150 within the stator or the motor of the linear compressor 100 such that motion of inner back iron 142 along the radial direction R is hindered or limited while motion along the axial direction A is relatively unimpeded. Thus, the planar springs 150 may be substantially stiffer along the radial direction R than along the axial direction A. In such a manner, planar springs 150 can assist with maintaining a uniformity of the air gap between driving magnet 144 and driving coil 124, e.g., along the radial direction R, during operation of the motor and movement of inner back iron 142 on the axial direction A. The planar springs 150 can also assist with hindering side pull forces of the motor from transmitting to piston 130 and being reacted in cylinder 117 as a friction loss.

A flex mount 160 is mounted to and extends through inner back iron 142. In particular, the flex mount 160 is mounted to inner back iron 142 via inner sleeve 148. Thus, the flex mount 160 may be coupled (e.g., threaded) to inner sleeve 148 at the middle portion of inner sleeve 148 and/or flex mount 160 in order to mount or fix flex mount 160 to inner sleeve 148. The flex mount 160 may assist with forming a coupling 162. The coupling 162 connects inner back iron 142 and piston 130 such that motion of inner back iron 142, e.g., along the axial direction A, is transferred to piston 130.

The coupling 162 may be a compliant coupling that is compliant or flexible along the radial direction R. In particular, coupling 162 may be sufficiently compliant along the radial direction R such that little or no motion of inner back iron 142 along the radial direction R is transferred to piston 130 by coupling 162. In such a manner, side pull forces of the motor are decoupled from piston 130 and/or cylinder 117 and friction between piston 130 and cylinder 117 may be reduced.

As may be seen in the figures, the piston head 132 of piston 130 has a piston cylindrical side wall 170. The cylindrical side wall 170 may extend along the axial direction A from piston head 132 towards inner back iron 142. An outer surface of cylindrical side wall 170 may slide on cylinder 117 at chamber 118 and an inner surface of cylindrical side wall 170 may be positioned opposite the outer surface of cylindrical side wall 170. Thus, the outer surface of cylindrical side wall 170 may face away from a center of cylindrical side wall 170 along the radial direction R, and the inner surface of cylindrical side wall 170 may face towards the center of cylindrical side wall 170 along the radial direction R.

The flex mount 160 extends between a first end portion 172 and a second end portion 174, e.g., along the axial direction A. According to an exemplary embodiment, the inner surface of cylindrical side wall 170 defines a ball seat 176 proximate first end portion. In addition, coupling 162 also includes a ball nose 178. Specifically, for example, the ball nose 178 is positioned at first end portion 172 of flex mount 160, and ball nose 178 may contact flex mount 160 at first end portion 172 of flex mount 160. In addition, ball nose 178 may contact piston 130 at ball seat 176 of piston 130. In particular, ball nose 178 may rest on ball seat 176 of piston 130 such that ball nose 178 is slidable and/or rotatable on ball seat 176 of piston 130. For example, ball nose 178 may have a frusto-spherical surface positioned against ball seat 176 of piston 130, and ball seat 176 may be shaped complementary to the frusto-spherical surface of ball nose 178. The frusto-spherical surface of ball nose 178 may slide and/or rotate on ball seat 176 of piston 130.

Relative motion between the flex mount 160 and the piston 130 at the interface between ball nose 178 and ball seat 176 of piston 130 may provide reduced friction between piston 130 and cylinder 117, e.g., compared to a fixed connection between flex mount 160 and piston 130. For example, when an axis on which piston 130 slides within cylinder 117 is angled relative to the axis on which inner back iron 142 reciprocates, the frusto-spherical surface of ball nose 178 may slide on ball seat 176 of piston 130 to reduce friction between piston 130 and cylinder 117 relative to a rigid connection between inner back iron 142 and piston 130.

Further, as shown, the flex mount 160 is connected to the inner back iron 142 away from first end portion 172 of flex mount 160. For example, flex mount 160 may be connected to inner back iron 142 at second end portion 174 of flex mount 160 or between first and second end portions 172, 174 of flex mount 160. Conversely, the flex mount 160 is positioned at or within piston 130 at first end portion 172 of flex mount 160, as discussed in greater detail below.

In addition, the flex mount 160 includes a tubular wall 190 between inner back iron 142 and piston 130. A channel 192 within tubular wall 190 is configured for directing compressible fluid, such as refrigerant or air, though flex mount 160 towards piston head 132 and/or into piston 130. Inner back iron 142 may be mounted to flex mount 160 such that inner back iron 142 extends around tubular wall 190, e.g., at the middle portion of flex mount 160 between first and second end portions 172, 174 of flex mount 160. Channel 192 may extend between first and second end portions 172, 174 of flex mount 160 within tubular wall 190 such that the compressible fluid is flowable from first end portion 172 of flex mount 160 to second end portion 174 of flex mount 160 through channel 192. In such a manner, compressible fluid may flow through inner back iron 142 within flex mount 160 during operation of the linear compressor 100. A muffler 194 may be positioned within channel 192 within tubular wall 190, e.g., to reduce the noise of compressible fluid flowing through channel 192.

The piston head 132 also defines at least one opening 196. Opening 196 of piston head 132 extends, e.g., along the axial direction A, through piston head 132. Thus, the flow of fluid may pass through piston head 132 via opening 196 of piston head 132 into chamber 118 during operation of the linear compressor 100. In such a manner, the flow of fluid (that is compressed by piston head 132 within chamber 118) may flow within channel 192 through flex mount 160 and inner back iron 142 to piston 130 during operation of the linear compressor 100. As explained above, suction valve 128 (FIGS. 6-7) may be positioned on piston head 132 to regulate the flow of compressible fluid through opening 196 into chamber 118.

Referring still to FIGS. 3 through 7, the linear compressor 100 may also include a lubrication system 200 for circulating a lubricant, e.g., such as oil, through the working or moving components of the linear compressor 100 to reduce friction, improve efficiency, etc. For example, as shown, the housing 102 may generally defines a sump 202 which is configured for collecting oil. Specifically, the sump 202 may be defined in the bottom portion of lower housing 104. The lubrication system 200 further includes a pump 206 for continuously circulating oil through components of the linear compressor 100 which need lubrication.

As also illustrated in the figures, the linear compressor 100 may include a suction inlet 220 for receiving a flow of refrigerant. Specifically, as shown, the suction inlet 220 may be defined on the housing 102 (e.g., such as on lower housing 104), and may be configured for receiving a refrigerant supply conduit to provide refrigerant to the cavity 108. As explained above, the flex mount 160 includes tubular wall 190, which defines channel 192 for directing compressible fluid, such as refrigerant gas, through flex mount 160 towards piston head 132. In this manner, desirable flow path of refrigerant gas is through suction inlet 220, through channel 192, through opening 196, and into chamber 118. Suction valve 128 may block opening 196 during a compression stroke and a discharge valve 116 may permit the compressed gas to exit chamber 118 when the desired pressure is reached.

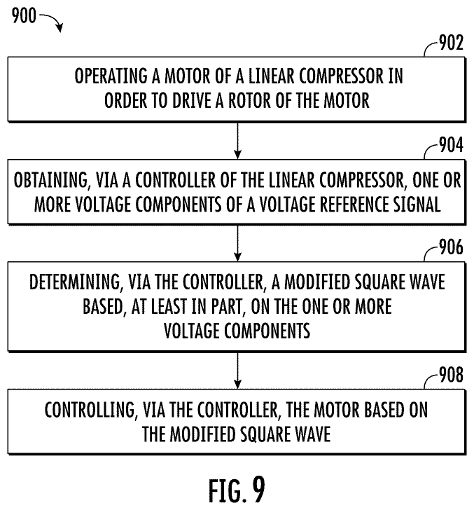

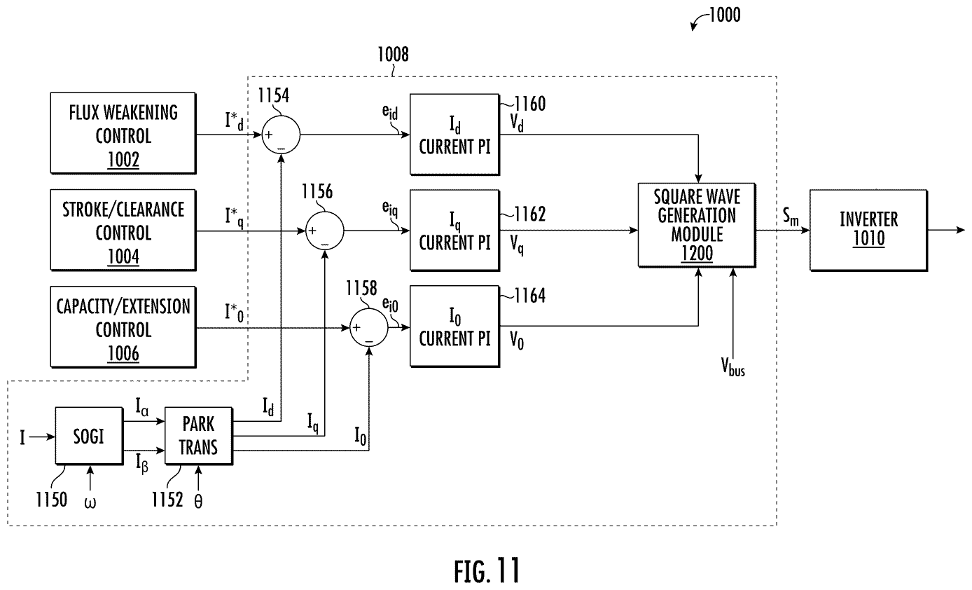

FIG. 9 depicts a flow diagram of an example method 900 for operating a linear compressor of an appliance according to example embodiments of the present disclosure. More particularly, the method 900 can be implemented to control a linear compressor of a refrigerator appliance (e.g., as depicted in FIGS. 1-2) using a single-phase vector-like control scheme (e.g., as depicted in FIG. 11). FIG. 9 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Additionally, method 900 is generally discussed with reference to the refrigerator appliance 10 described above with reference to FIGS. 1-2 and the linear compressor 100 described above with reference to FIGS. 3-8. However, it should be understood that aspects of the present method 900 can find application with any suitable appliance and/or linear compressor.

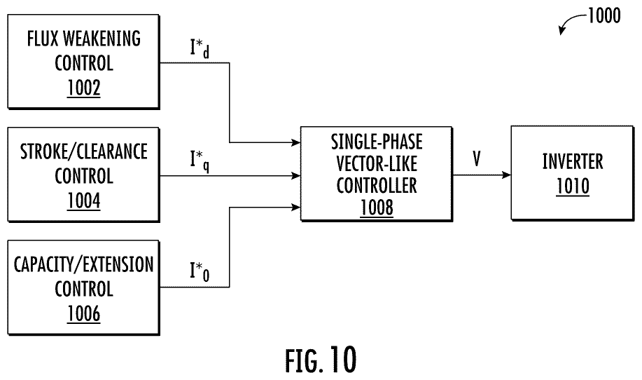

As noted above, the method 900 provides a method for controlling a linear compressor (e.g., linear compressor 100) of an appliance (e.g., refrigerator appliance 10). The method 900, at (902), operating a motor of the linear compressor in order to drive a rotor of the motor. In some embodiments, the linear compressor can include a single-phase motor such as, e.g., a single-phase linear motor. More particularly, a controller can be configured to implement a control scheme (e.g., a single-phase vector-like control scheme 1000 (e.g., as depicted in FIGS. 10-11)) to operate a motor of the linear compressor (e.g., linear compressor 100) in order to drive a rotor (e.g., rotor coupled to piston 130) of the motor.

The method 900 can include, at (904), obtaining, via the single-phase vector-like controller 1008, one or more voltage components of a voltage reference signal (V). More particularly, the single-phase vector-like controller 1008 can be configured to obtain a DC voltage component (V₀), a d-axis component (V_{d}), and a q-axis component (V_{q}) from respective Current PI 1160, 1162, 1164, as described above. Further, the single-phase vector-like controller 1008 can be configured to obtain one or more feedback measurements (e.g., current feedback, voltage feedback, etc.) of one or more electrical characteristics (e.g., current, voltage, magnetic flux, etc.) of the motor.

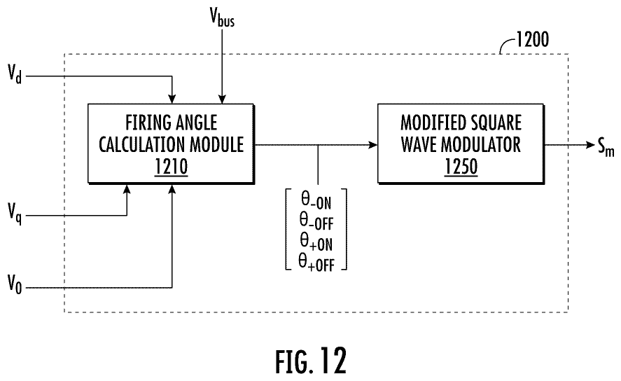

The method 900 may also include, at (906), determining, via the single-phase vector-like controller 1008, a modified square wave (Sₘ) based, at least in part, on the one or more voltage components (V₀), (V_{d}), (V_{q}). For instance, the single-phase vector-like controller 1008 can be configured to determine positive and negative duty cycles (D₊), (D₋) of the modified square wave (Sₘ) based on the one or more voltage components (V₀), (V_{d}), (V_{q}), as will be described in further detail below in regards to FIG. 12. Further, the single-phase vector-like controller 1008 can be configured to determine a plurality of firing angles (θ_{-ON}, θ_{-OFF}, θ_{+ON}, θ_{+OFF}) defining the duty cycles (D₊), (D₋), as will be described in further detail below in regards to FIG. 12.

The method 900 may also include, at (908), controlling, via the single-phase vector-like controller 1008, the motor based on the modified square wave (Sₘ). For instance, the modified square wave (Sₘ) can be configured to achieve the reference voltage signal (V). That is, the single-phase vector-like controller 1008 can implement voltage transitions based on the plurality of firing angles (θ_{-ON}, θ_{-OFF}, θ_{+ON}, θ_{+OFF}) of the modified square wave (Sₘ) so as to output a voltage that has the same effect on the linear compressor as the reference voltage signal (V). In some embodiments, the single-phase vector-like controller 1008 can be further configured to determine a running average of the voltage output based on the modified square wave (Sₘ). In such embodiments, the single-phase vector-like controller 1008 can be further configured to terminate a negative pulse of the modified square wave (Sₘ) when the running average of the voltage equals the DC voltage component (V₀) of the reference voltage signal (V).

Controlling the motor using the modified square wave (Sₘ) reduces frequency of output state transitions implemented by the inverter 1010 when outputting voltage to the motor as compared to typical pulse width modulation (PWM) schemes (e.g., that use a switching frequency much greater than the fundamental harmonic frequency of motor displacement).

Switching losses of the inverter 1010 are directly proportional to the number of switches implemented by the inverter 1010. Hence, reducing the number of switches reduces the switching losses of the inverter 1010. While controlling the motor based on the modified square wave (Sₘ) can cause increased conduction losses of the motor (relative to higher switching frequency PWM schemes), the magnitude of this increase can be reduced by the inductance of the stator. As such, the reduced switching losses can outweigh the increased conduction losses, which can result in improved efficiency of the linear compressor. Moreover, the modified square wave (Sₘ) provides a switching frequency that is much lower than typical PWM schemes, which allows for a cost reduction by utilizing slower transitioning switches in the inverter 1010 that are generally cheaper than faster transitioning switches.

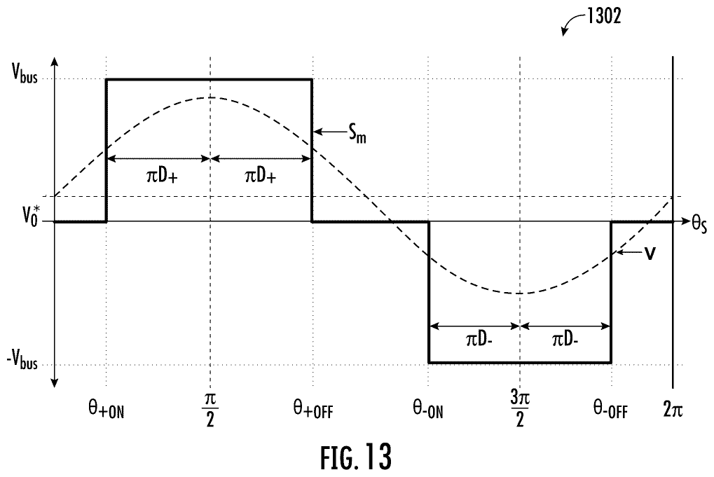

The method of FIG. 9 can be better understood with reference to FIGS. 10-14. In particular, FIG. 10 depicts an example control scheme operable to control a linear compressor (e.g., linear compressor 100) of an appliance (e.g., refrigerator appliance 10) according to example embodiments of the present disclosure. FIG. 11 depicts an example embodiment of a single-phase vector-like controller 1008 implementing single-phase DQ0 control. FIG. 12 illustrates a control diagram of an example square wave generation module 1200 of the single-phase vector-like controller 1008 according to one or more exemplary embodiments of the present disclosure. FIG. 13 illustrates a plot of a modified square wave (Sₘ) configured to achieve a reference voltage signal (V) according to one or more example embodiments of the present disclosure. FIG. 13 illustrates correlated plots of testing results of the inverter 1010 implementing the modified square wave (Sₘ) to control a motor of the linear compressor according to one or more additional example embodiments of the present disclosure.

As shown in the embodiment illustrated in FIG. 10, a controller can be operably coupled to the motor of the linear compressor and can be configured to implement a single-phase vector-like control scheme (e.g., control scheme 1000) to operate a motor of the linear compressor in order to drive a rotor (e.g., rotor coupled to piston 130) of the motor. More particularly, the control scheme 1000 can include a stroke controller 1004 (e.g., clearance controller 1004) and a capacity controller 1006 (e.g., extension controller 1006). In some embodiments, as shown, the control scheme 1000 may include a flux-weakening controller 1002. As discussed in more detail below, the flux-weakening controller 1002 can be configured to control a d-axis current component of the motor, the stroke controller 1004 (e.g., clearance controller 1004) can be configured to control a q-axis current component of the motor, and the capacity controller 1006 (e.g., extension controller 1006) can be configured to control a target DC current component of the motor. Furthermore, as will be discussed in more detail below with reference to FIG. 11, the control scheme 1000 can further include a single-phase vector-like controller 1008. The single-phase vector-like controller 1008 can be operatively coupled to the flux-weakening controller 1002, the stroke controller 1004, and the capacity controller 1006. The control scheme 1000 can further include an inverter 1010 configured to supply a variable frequency waveform to the motor. Furthermore, as will be discussed in greater detail below, the single-phase vector-like controller 1008 can be configured to determine the requisite voltage needed by the inverter 1010 in order to drive the motor based, at least in part, on the d-axis current component, the q-axis current component, and the DC current component.

As noted above, in some embodiments, the motor can be a single-phase linear motor. The single-phase linear motor can have a stator and a rotor. The rotor can be operatively coupled to a piston (e.g., a reciprocating piston) that compresses gas when operated. In some embodiments, the piston can be fitted with springs in order to allow resonant oscillation to facilitate the compression by the piston.

A total magnetic flux (λ) produced by the motor includes a rotor component (λᵣ) and a stator component (λₛ). When the rotor is centered in the stator (i.e., x=0), total rotor flux (λᵣ) linked to the stator is zero. When the rotor moves forward and/or backward from the center of the stator, the rotor flux (λᵣ) increases and decreases, respectively, in a linear manner. Moreover, windings of the stator produce a stator flux proportional to a winding current in the stator winding (I) by the inductance (L). More particularly, the total flux (λ) is given by Equations (1)-(3):

λᵣ≈αx (1)

λₛ=LI (2)

λ=λₛ+λᵣ=LI+αx (3)

When the total flux (λ) changes, an electromotive force voltage (EMF) is produced in the motor. More particularly, the EMF (ε) is given by Equation (4):

ε=λ=Lİ+α\dot{x} (4)

where \dot{λ} is a time derivative of the total flux, İ is a time derivative of the stator winding current, \dot{x} is a time derivative of the rotor position, and a is a motor constant. Furthermore, ax represents a back-EMF voltage (back-EMF) of the motor.

Taking into account Equation (4), a reference voltage signal (V) for the motor is given by Equation (5):

V=RI+Lİ+α\dot{x} (5)

where R is a resistance of the stator windings.

As noted above, in some embodiments, the piston can be fitted with springs to allow the resonant oscillation to facilitate the compression by the piston. More particularly, the piston oscillates in an approximately sinusoidal manner. The sinusoidal oscillation of the piston is given by Equation (6):

x(t)=x₁ sin θ+x₀ (6)

where θ represents a piston displacement phase angle, x₁ represents an amplitude of the piston displacement, and x₀ represents a midpoint of the piston displacement. Those of ordinary skill in the art will understand that the asymmetric force of gas compression can induce a positive offset in the position of the sine waveform.

Taking the above-equation, the time derivative of the rotor position (for use in the total motor voltage equation) can be derived. More particularly, the time derivative of the rotor position is given by Equation (7):

\dot{x}(t)=ωx₁ cos θ (7)

where ω=0.

Referring still to FIG. 10, the control scheme 1000 can be configured to control the amplitude of the motor current (I) and the relative phase between the motor current (I) and the back-EMF. Those of ordinary skill in the art will understand that current which is in-phase with the back-EMF generates a net force which increases stroke and capacity of the linear compressor. Likewise, those of ordinary skill in the art will understand that current which is out-of-phase with the back-EMF does not generate a net force but does affect the reference voltage (V) needed by the inverter (e.g., inverter 1010) to drive the motor. In this way, the out-of-phase current can be useful for flux-weakening operations.

The piston displacement phase angle (θ) can be used to define an in-phase component and an out-of-phase component of the approximately sinusoidal motor current (I). The total motor current (I) and its time derivative (İ) are given by Equations (10)-(11):

I(t)=I_{d} sin θ+I_{q} cos θ+I₀ (10)

İ(t)=İ_{d} sin θ+ωI_{d} cos θ+İ_{q} cos θ−ωI_{q} sin θ+İ₀ (11)

where I_{d} is the amplitude of the current component that is out-of-phase with the back-EMF (i.e., in-phase with the rotor flux), I_{q} is the amplitude of the current component that is in-phase with the back-EMF (i.e., out-of-phase with the rotor flux), and I₀ is the amplitude of the DC current.

Thus, substituting I(t), İ(t), and \dot{x}(t) into Equation 5, the reference voltage signal (V) for the motor can be represented by Equations (12)-(13):

V=(RI_{d}+Lİ_{d}−LωI_{q})sin θ+(RI_{q}+Lİ_{q}+LωI_{d}+αωx₁)cos θ+RI₀+Lİ₀ (12)

V=V_{d} sin θ+V_{q} cos θ+V₀ (13)

where V_{d} is the amplitude of the voltage component that is out-of-phase with the back-EMF (i.e., in-phase with the rotor flux), V_{q} is the amplitude of the voltage component that is in-phase with the back-EMF (i.e., out-of-phase with the rotor flux), and V₀ is the amplitude of the DC voltage.

As such, in the dq frame, the electrical dynamics of the stator windings can be given by Equation (14):

$$[ \begin{matrix}{V}_{d} \\ {V}_{q} \\ {V}_{0}\end{matrix} ] = [ \begin{matrix}( sL + R ) & - L ω & 0 \\ L ω & ( sL + R ) & 0 \\ 0 & 0 & ( sL + R )\end{matrix} ] [ \begin{matrix}{I}_{d} \\ {I}_{q} \\ {I}_{0}\end{matrix} ] + [ \begin{matrix}0 \\ αω {x}_{1} \\ 0\end{matrix} ] \qquad ( 14 )$$

where s is a Laplace variable. Those of ordinary skill in the art will understand that the above-described equations directly parallel the dq voltage equations for a three-phase permanent magnet synchronous motor (PMSM). In this way, the present disclosure provides a single-phase vector-like control scheme that is analogous to a field-oriented control scheme commonly used in three-phase motors such as, e.g., PMSMs and brushless DC (BLDC) motors.

As mentioned above, in some embodiments, the flux-weakening controller 1002 may be configured to control the d-axis current component of the motor current. More particularly, the flux-weakening controller 1002 may be configured to determine the target d-axis current component

$$( {I}_{d}^{*} ) .$$

For instance, the flux-weakening controller 1002 can be configured to adjust the target d-axis current component

$$( {I}_{d}^{*} )$$

based, at least in part, on one or more feedback measurements (e.g., current feedback, voltage feedback, etc.) of one or more electrical characteristics (e.g., current, voltage, magnetic flux, etc.) of the motor. In other embodiments, the control scheme 1000 may lack the flux-weakening controller 1002. In such embodiments, the target d-axis current component

$$( {I}_{d}^{*} )$$

can be set to a specified value (e.g., zero (0)). Those of ordinary skill in the art will understand that the target d-axis current component

$$( {I}_{d}^{*} )$$

can be adjusted in any suitable manner without deviating from the scope of the present disclosure.

As mentioned above, the stroke controller 1004 (e.g., clearance controller 1004) may be configured to control the q-axis current component of the motor current. More particularly, the stroke controller 1004 can be configured to determine a target q-axis current component

$$( {I}_{q}^{*} ) .$$

For instance, the stroke controller 1004 can be configured to adjust the target q-axis current component

$$( {I}_{q}^{*} )$$

based, at least in part, on the one or more feedback measurements (e.g., current feedback). Those of ordinary skill in the art will understand that the target q-axis current component

$$( {I}_{q}^{*} )$$

can be adjusted in any suitable manner without deviating from the scope of the present disclosure.

As mentioned above, the capacity controller 1006 (e.g., extension controller 1006) may be configured to control the DC current component of the motor current. More particularly, the capacity controller 1006 can be configured to control a target DC current component

$$( {I}_{0}^{*} ) .$$

For instance, the capacity controller 1006 can be configured to adjust the target DC current component

$$( {I}_{0}^{*} )$$

based, at least in part, on the one or more feedback measurements (e.g., current feedback). Those of ordinary skill in the art will understand that the target DC current component

$$( {I}_{0}^{*} )$$

can be adjusted in any suitable manner without deviating from the scope of the present disclosure.

In some embodiments, the control scheme 1000 can include a sensored feedback system (not shown) configured to obtain the one or more feedback measurements. For instance, in some embodiments, the control scheme 1000 can include a sensor (e.g., encoder, Hall effect sensor, etc.) configured to obtain a velocity signal and a phase-locked loop (PLL) configured to extract the frequency and phase from the velocity signal.

In other embodiments, the control scheme 1000 can include a sensorless feedback system (not shown) configured to obtain the one or more feedback measurements. As used herein, a “sensorless” feedback system can refer to any feedback system operable to determine data indicative of a position or a speed of the motor without a position sensor or a speed sensor. For instance, in some embodiments, the control scheme 1000 can include, e.g., an observer (not shown) configured to estimate back-EMF and/or velocity based, at least in part, on voltage and/or current signals of the motor. The back-EMF signal and/or the velocity signal can then be fed into a PLL (as described above) to extract the frequency and phase of the corresponding signal.

The target d-axis current component

$$( {I}_{d}^{*} ) ,$$

target q-axis current component

$$( {I}_{q}^{*} ) ,$$

and target DC current component

$$( {I}_{0}^{*} )$$

can then be passed to the single-phase vector-like controller 1008. As noted above, the single-phase vector-like controller 1008 can be configured to determine a reference voltage signal (V) required by the inverter 1010 in order to drive the motor based, at least in part, on the target d-axis current component

$$( {I}_{d}^{*} ) ,$$

the target q-axis current component

$$( {I}_{q}^{*} ) ,$$

and the target DC current component

$$( {I}_{0}^{*} ) .$$

Referring now to FIG. 11, in embodiments, the controller can be configured to implement single-phase DQ0 control. In such embodiments, the single-phase vector-like controller 1008 can be configured to determine an actual d-axis current component (I_{d}), an actual q-axis current component (I_{q}), and an actual DC current component (I₀) based, at least in part, on the current feedback measurements (I). The control scheme 1000 can then use the actual d-axis current component (I_{d}), the actual q-axis current component (I_{q}), and the actual DC current component (I₀) to determine the reference voltage signal (V) for the motor.

The controller (e.g., via control scheme 1000) can be configured to adjust the target q-axis current component

$$( {I}_{q}^{*} )$$

based at least in part, on the one or more feedback measurements. Further, the controller (e.g., via control scheme 1000) can be configured to adjust the target DC current component

$$( {I}_{0}^{*} ) .$$

Furthermore, in some embodiments, the controller (e.g., via control scheme 1000) can be configured to adjust the target d-axis current component

$$( {I}_{d}^{*} )$$

based, at least in part, on the one or more feedback measurements. In other embodiments, the controller (e.g., via control scheme 1000) can be configured to set the target d-axis current component

$$( {I}_{d}^{*} )$$

to zero.

The control scheme 1000 can be configured to obtain current feedback measurements (I) and piston displacement feedback measurements. For example, the control scheme 1000 can include a second-order generalized integrator 1150 (SOGI 1150) and a Park transform 1152 which, when used in tandem, can be configured to determine the actual d-axis current component (I_{d}), the actual q-axis current component (I_{q}), and the actual DC current component (I₀) of the current feedback measurements (I). In order to determine the actual d-axis current component (I_{d}), the actual q-axis current component (I_{q}), and the actual DC current component (I₀) of the current feedback measurements, the SOGI 1150 uses the frequency component (ω) of the piston displacement feedback measurements, and the Park Transform 1152 uses the phase angle (θ) of the piston displacement feedback measurements.

The controller (e.g., via control scheme 1000) can be configured to determine a d-axis current error signal (e_{id}) between the target d-axis current component

$$( {I}_{d}^{*} )$$

and the actual d-axis current component (I_{d}) of the current feedback measurements (I). For instance, referring still to FIG. 11, the control scheme 1000 can be configured to determine the current error signal

$$( {I}_{d}^{*} )$$

and the actual d-axis current component (I_{d}) of the current feedback measurements (I).

The controller (e.g., via control scheme 1000) can be configured to determine a q-axis current error signal (e_{iq}) between the target q-axis current

$$( {I}_{q}^{*} )$$

and the actual q-axis current component (I_{q}) of the current feedback measurements (I). For instance, the control scheme 1000 can be configured to determine the q-axis current error signal (e_{iq}) (e.g., via a comparator 1156) between the q-axis current setpoint

$$( {I}_{q}^{*} )$$

and the actual q-axis current component (I_{q}) of the current feedback measurements (I).

The controller (e.g., via control scheme 1000) can be configured to determine a DC current error signal (eᵢ₀) between the target DC current

$$( {I}_{0}^{*} )$$

and the actual DC current component (I₀) of the current feedback measurements (I). For instance, the control scheme 1000 can be configured to determine the DC current error signal (eᵢ₀) (e.g., via a comparator 1158) between the DC current setpoint

$$( {I}_{0}^{*} )$$

and the actual DC current component (I₀) of the current feedback measurements (I).

The controller (e.g., via control scheme 1000) can be configured to adjust the DC voltage component (V₀) based, at least in part, on the DC current error signal (eᵢ₀). For instance, the control scheme 1000 can include a DC current proportional-integral controller (PI) 1164 (e.g., I₀ Current PI 1164). The DC current PI 1164 can be configured to determine the DC voltage component (V₀) based, at least in part, on the DC current error signal (eᵢ₀). Those of ordinary skill in the art will understand that the DC voltage component (V₀) can be adjusted in any suitable manner without deviating from the scope of the present disclosure.

The controller (e.g., via control scheme 1000) can be configured to adjust the d-axis voltage component (V_{d}) based on the d-axis current error signal (e_{id}) and/or the q-axis current error signal (e_{iq}). Those of ordinary skill in the art will understand that the d-axis voltage component (V_{d}) can be adjusted in any suitable manner without deviating from the scope of the present disclosure. For instance, in some embodiments, the control scheme 1000 can include a d-axis current PI 1160 (e.g., I_{d} Current PI 1160). The d-axis current PI 1160 can be configured to determine the d-axis voltage component (V_{d}) based, at least in part, on the d-axis current error signal (e_{id}). In other embodiments, the controller (e.g., via control scheme 1000) may be configured to decouple the q-axis and d-axis current error signals (e_{iq}), (e_{id}) from the q-axis and d-axis voltage components (V_{q}), (V_{d}). As such, the controller may be configured to determine the DQ0 voltage components (Vₒ), (V_{d}), (V_{q}) sequentially. More specifically, the controller can determine the DC voltage component (Vₒ) prior to the d-axis voltage component (V_{d}). Further, the controller can determine the d-axis voltage component (V_{d}) prior to the q-axis voltage component (V_{q}). In such embodiments, the d-axis current PI 1160 can be configured to determine the d-axis voltage component (V_{d}) based additionally on the q-axis current error signal (e_{iq}).

For instance, in one example implementation in accordance with one or more embodiments of the present disclosure, the design of the DC current PI 1164, the d-axis current PI 1160, and the q-axis current PI 1162 may be based on Equation (15):

$$[ \begin{matrix}{V}_{d}^{*} \\ {V}_{q}^{*} \\ {V}_{0}^{*}\end{matrix} ] = [ \begin{matrix}{k}_{p d} + \frac{{k}_{idd}}{s} & - \frac{{k}_{idq}}{s} & 0 \\ \frac{{k}_{i q d}}{s} & {k}_{p q} + \frac{{k}_{i q q}}{s} & 0 \\ 0 & 0 & {k}_{p o} + \frac{{k}_{i 0}}{s}\end{matrix} ] [ \begin{matrix}{e}_{i d} \\ {e}_{i q} \\ {e}_{i 0}\end{matrix} ] \qquad ( 15 )$$

where k_{pd} is a first proportional gain, k_{pq} is a second proportional gain, kₚ₀ is a third proportional gain, and k_{idd}, k_{idq}, k_{iqq}, k_{iqd}, and kᵢ₀ are integral gains.

As can be seen, the d-axis voltage component (V_{d}) and the q-axis voltage component (V_{q}) are dependent on (i.e., cross-coupled with) the q-axis and d-axis current error signals (e_{iq}), (e_{id}). Furthermore, the cross-coupled integral gains k_{idq}, k_{iqd} are frequency dependent such that the amount of cross-coupling increases as the frequency of the motor increases. More particularly, the cross-coupled integral gains k_{idq}, k_{iqd} are related to the pole frequency, represented by ωₚ, of the motor. In particular the pole frequency is determined by the equation:

$${ω}_{p} = \frac{R}{L} .$$

As such, at low frequencies (i.e., when the frequency of the motor is much less than the pole frequency), the diagonal integral terms k_{idd}, k_{iqq} will dominate AC voltages and comparatively little cross-coupling will occur. However, during operation of some linear compressors, the frequency of the motor is much greater than the pole frequency, such that the cross-coupled integral gains k_{idq}, k_{iqd} will dominate the AC voltages. Hence, Equation (15) can be simplified to remove the diagonal gains k_{idd}, k_{iqq}, k_{pd}, k_{pq} as shown in Equation (16):

$$[ \begin{matrix}{V}_{d}^{*} \\ {V}_{q}^{*} \\ {V}_{0}^{*}\end{matrix} ] = [ \begin{matrix}0 & - \frac{{k}_{i d q}}{s} & 0 \\ \frac{{k}_{i q d}}{s} & 0 & 0 \\ 0 & 0 & {k}_{p 0} + \frac{{k}_{i 0}}{s}\end{matrix} ] [ \begin{matrix}{e}_{i d} \\ {e}_{i q} \\ {e}_{i 0}\end{matrix} ] \qquad ( 16 )$$

The controller (e.g., via control scheme 1000) can be configured to adjust the q-axis voltage component (V_{q}) based on the d-axis current error signal (e_{id}) and/or the q-axis current error signal (e_{iq}). For instance, the control scheme 1000 can include a q-axis current PI 1162 (e.g., I_{q} Current PI 1162). The q-axis current PI 1162 can be configured to determine the q-axis voltage component (V_{qd}) based, at least in part, on the q-axis current error signal (e_{iq}). In some embodiments (e.g., when the controller is configured to decouple the q-axis and d-axis current error signals (e_{iq}), (e_{id}) from the q-axis and d-axis voltage components (V_{q}), (V_{d})), the q-axis current PI 1162 can be configured to determine the q-axis voltage component (V_{q}) based additionally on the d-axis current error signal (e_{id}). Those of ordinary skill in the art will understand that the q-axis voltage component (V_{q}) can be adjusted in any suitable manner without deviating from the scope of the present disclosure.

Furthermore, referring to FIG. 11, the d-axis voltage component (V_{d}), the q-axis voltage component (V_{q}), and the DC voltage component (V₀) can be provided to the square wave generation module 1200. The square wave generation module 1200 can be configured to output a modified square wave (Sₘ). The modified square wave (Sₘ) can then be sent to the inverter 1010.

Referring now to FIG. 12, the square wave generation module 1200 can be configured to output the modified square wave (Sₘ) that is configured to achieve the reference voltage signal (V). That is, the inverter 1010 can implement voltage transitions (e.g., switch between applying no voltage, a positive DC bus voltage V_{bus}, and a negative DC bus voltage −V_{bus}) based on the modified square wave (Sₘ) so as to produce an effective output voltage equivalent to the reference voltage signal (V) (FIG. 13). For instance, the square wave generation module 1200 can include a firing angle calculation module 1210 and a modified square wave modulator 1250. The firing angle calculation module 1210 can be configured to determine a plurality of firing angles (θ_{-ON}, θ_{-OFF}, θ_{+ON}, θ_{+OFF}) based, at least in part, on the d-axis voltage component (Va), the q-axis voltage component (V_{q}), the DC voltage component (V₀), as will be described in further detail below. The modified square wave modulator 1250 can be configured to generate the modified square wave (Sₘ) based, at least in part, on the plurality of firing angles (θ_{-ON}, θ_{-OFF}, θ_{+ON}, θ_{+OFF}). More particularly, the modified square wave modulator 1250 can receive the plurality of firing angles (θ_{-ON}, θ_{-OFF}, θ_{+ON}, θ_{+OFF}) from the firing angle calculation module 1200. Further, the modified square wave modulator 1250 can use a phase (θₛ) of the total voltage (V) to generate the modified square wave (Sₘ) based on Equation (17):

$${S}_{m} = \{ \begin{matrix}{V}_{bus} & if {θ}_{+ ON} \leq {θ}_{s} \leq {θ}_{+ OFF} \\ - {V}_{bus} & if {θ}_{- ON} \leq {θ}_{s} \leq {θ}_{- OFF} \\ 0 & else\end{matrix} \qquad ( 17 )$$

where Sₘ is the waveform of the modified square wave.

The modified square wave modulator 1250 can, for example, obtain voltage feedback measurements (e.g., the phase (θₛ) of the reference voltage signal (V)). Additionally, or alternatively, the modified square wave modulator 1250 can determine the phase (θₛ) of the reference voltage signal (V) based, at least in part, on the d-axis voltage component (V_{d}), the q-axis voltage component (V_{q}), and the DC voltage component (V₀) (e.g., by using Equations (40) and (44) below).

As an illustrative example, FIG. 13 depicts a chart 1302 of the reference voltage signal (V) and the modified square wave (Sₘ). Chart 1302 depicts the reference voltage signal (V) and the modified square wave (Sₘ) represented in volts (y-axis) over the phase (θₛ) of the total voltage (V) (x-axis). As shown, the plurality of firing angles (θ_{-ON}, θ_{-OFF}, θ_{+ON}, θ_{+OFF}) includes a set of positive firing angles (θ_{+ON}, θ_{+OFF}) defining a positive duty cycle (D₊) of the modified square wave (Sₘ), and a set of negative firing angles (θ_{-ON}, θ_{-OFF},) defining a negative duty cycle (D₋) of the modified square wave (Sₘ). The duty cycles (D₊), (D₋) can represent durations of positive and negative pulses of the modified square wave (Sₘ). Accordingly, the duty cycles (D₊), (D₋) may be given by Equations (18)-(19):

$${D}_{+} = \frac{{θ}_{+ O F F} - {θ}_{+ O N}}{2 π} \qquad ( 18 )$$

$${D}_{-} = \frac{{θ}_{- O F F} - {θ}_{- O N}}{2 π} \qquad ( 19 )$$

Further, a sum duty cycle (D_{Σ}) and a difference duty cycle (D_{Δ}) can be defined based on Equations (20)-(21):

D_{Σ}=D₊+D₋ (20)

D_{Δ}=D₊−D₋ (21)

Since Equations (20)-(21) are an invertible linear combination, the duty cycles (D₊), (D₋) can be expressed according to Equations (22)-(23):

$${D}_{+} = \frac{1}{2} ( {D}_{\sum } + {D}_{Δ} ) \qquad ( 22 )$$

$${D}_{-} = \frac{1}{2} ( {D}_{\sum } - {D}_{Δ} ) \qquad ( 23 )$$

Moreover, as shown, a midpoint of the positive pulse of the modified square wave (Sₘ) is aligned with a positive peak of the reference voltage signal (V), which occurs at

$${θ}_{s} = \frac{π}{2} ,$$

and a midpoint of a negative pulse of the modified square wave (Sₘ) is aligned with a negative peak of the reference voltage signal (V)), which occurs at

$${θ}_{s} = \frac{3 π}{2} .$$

As such, the plurality of firing angles (θ_{-ON}, θ_{-OFF}, θ_{+ON}, θ_{+OFF}) can be represented by Equation (24):

$$[ \begin{matrix}{θ}_{- ON} \\ {θ}_{- O F F} \\ {θ}_{+ O N} \\ {θ}_{+ OFF}\end{matrix} ] = [ \begin{matrix}\frac{3 π}{2} - π {D}_{-} \\ \frac{3 π}{2} + π {D}_{-} \\ \frac{π}{2} - π {D}_{+} \\ \frac{π}{2} + π {D}_{+}\end{matrix} ] \qquad ( 24 )$$

Referring back to FIG. 12, the firing angle calculation module 1210 can be configured to determine the duty cycles (D₊), (D₋) based, at least in part, on the d-axis voltage component (V_{d}), the q-axis voltage component (V_{q}), the DC voltage component (V₀), and the DC bus voltage (V_{bus}). More particularly, at steady-state, the modified square wave (Sₘ) may be periodic with a period 2π. Accordingly, the waveform of the modified square wave (Sₘ) can be approximated in Fourier series form by Equations (25)-(26):

Vₛ=a₀+a₁ cos θₛ+b₁ sin θₛ=a₀+C₁ sin(θₛ−φ₁) (25)

C₁=(a₁²+b₁²) (26)

where Vₛ is the Fourier approximation of the modified square wave (Sₘ), a₀ is the dc offset, a₁ and b₁ are amplitudes of the fundamental harmonic cosine and sine terms, C₁ is the ac magnitude of the fundamental harmonic, and φ₁ is the phase shift of the fundamental harmonic relative to the reference voltage (V).

The Fourier coefficients of Equation (25) can be calculated using Equations (27)-(29):

$${a}_{0} = \frac{1}{2 π} {\int }_{0}^{2 π} {S}_{m} d {θ}_{s} \qquad ( 27 )$$

$${a}_{1} = \frac{1}{π} {\int }_{0}^{2 π} {S}_{m} cos ( {θ}_{s} ) d {θ}_{s} \qquad ( 28 )$$

$${b}_{1} = \frac{1}{π} {\int }_{0}^{2 π} {S}_{m} sin ( {θ}_{s} ) d {θ}_{s} \qquad ( 29 )$$

Taking Equations (17) and (27), the dc offset (a₀) can be represented by Equation (30):

$$\begin{matrix}{a}_{0} = \frac{1}{2 π} {\int }_{{θ}_{+ ON}}^{{θ}_{+ OFF}} {V}_{b u s} d {θ}_{s} + {\int }_{{θ}_{- ON}}^{{θ}_{- OFF}} - {V}_{b u s} d {θ}_{s} \\ = \frac{{V}_{b u s}}{2 π} ( {θ}_{s} {\vert}_{{θ}_{+ ON}}^{{θ}_{+ OFF}} - {θ}_{s} {\vert}_{{θ}_{- IN}}^{{θ}_{- OFF}} ) \\ = \frac{{V}_{b u s}}{2 π} ( ( {θ}_{+ O F F} - {θ}_{+ O N} ) - ( {θ}_{- O F F} - {θ}_{- O N} ) )\end{matrix} \qquad ( 30 )$$

Combining Equations (20) and (30), the dc offset (a₀) can be re-written as Equation (31):

a₀=V_{bus}(D₊−D₋)=V_{bus}D_{Δ} (31)

Further, taking Equations (17) and (28), the fundamental cosine offset (a₁) can be represented according to Equation (32):

$$\begin{matrix}{a}_{1} = \frac{1}{π} {\int }_{{θ}_{+ ON}}^{{θ}_{+ OFF}} {V}_{b u s} cos ( {θ}_{s} ) d {θ}_{s} + {\int }_{{θ}_{- ON}}^{{θ}_{- OFF}} - {V}_{b u s} cos ( {θ}_{s} ) d {θ}_{s} \\ = \frac{{V}_{b u s}}{π} ( sin ( {θ}_{s} ) {\vert}_{{θ}_{+ ON}}^{{θ}_{+ OFF}} - sin ( {θ}_{s} ) {\vert}_{{θ}_{- ON}}^{{θ}_{- OFF}} ) \\ = \frac{{V}_{b u s}}{π} ( ( sin {θ}_{+ OFF} - sin {θ}_{+ O N} ) - ( sin {θ}_{- OFF} - sin {θ}_{- O N} ) )\end{matrix} \qquad ( 32 )$$

Substituting the firing angles of Equation (24) into Equation (32) gives Equation (33):

$${a}_{1} = \frac{{V}_{b u s}}{π} ( sin ( \frac{π}{2} + π {D}_{+} ) - sin ( \frac{π}{2} - π {D}_{+} ) ) - ( sin ( \frac{3 π}{2} + π {D}_{-} ) + ( \frac{3 π}{2} - π {D}_{-} ) ) \qquad ( 33 )$$

Applying the trigonometric relationship sin (α+β)−sin(α−β)=2 cos(α)sin(β) to Equation (33) results in Equation (34):

$${a}_{1} = \frac{{V}_{b u s}}{π} ( 2 cos ( \frac{π}{2} ) sin ( π {D}_{+} ) - 2 cos ( \frac{3 π}{2} ) sin ( π {D}_{-} ) ) = 0 \qquad ( 34 )$$

$$where α = \frac{π}{2} , \frac{3 π}{2} , β = π {D}_{+} , π {D}_{-} , and cos ( \frac{π}{2} ) = cos ( \frac{3 π}{2} ) = 0 .$$

Furthermore, taking Equations (17) and (28), the fundamental sine offset (b₁) can be represented according to Equation (35):

$$\begin{matrix}{b}_{1} = \frac{1}{π} {\int }_{{θ}_{+ ON}}^{{θ}_{+ OFF}} {V}_{b u s} sin ( {θ}_{s} ) d {θ}_{s} + {\int }_{{θ}_{- ON}}^{{θ}_{- OFF}} - {V}_{b u s} sin ( {θ}_{s} ) d {θ}_{s} \\ = \frac{{V}_{b u s}}{π} ( - cos ( {θ}_{s} ) {\vert}_{{θ}_{- ON}}^{{θ}_{- OFF}} + cos ( {θ}_{s} ) {\vert}_{{θ}_{+ ON}}^{{θ}_{+ OFF}} ) \\ = \frac{- {V}_{b u s}}{π} ( ( cos ( {θ}_{- OFF} ) - cos ( {θ}_{- ON} ) ) - ( cos ( {θ}_{+ OFF} ) - cos ( {θ}_{+ ON} ) ) )\end{matrix} \qquad ( 35 )$$

Applying the trigonometric relationship cos(α−β)−cos(α+β)=2 sin(α)sin(β) to Equation (35) results in Equation (36):

$$\begin{matrix}{b}_{1} = \frac{- {V}_{bus}}{π} ( 2 sin ( \frac{3 π}{2} ) sin ( - π {D}_{-} ) - 2 sin ( \frac{π}{2} ) sin ( - π {D}_{+} ) ) \\ = \frac{2 {V}_{bus}}{π} ( sin ( π {D}_{-} ) + sin ( π {D}_{+} ) )\end{matrix} \qquad ( 36 )$$

$$where α = \frac{3 π}{2} , \frac{π}{2} , β = - π {D}_{-} , - π {D}_{+} , sin ( \frac{π}{2} ) = 1 ,$$

$$sin ( \frac{3 π}{2} ) = - 1 , and sin ( - θ ) = - sin ( θ ) .$$

Moreover, applying the trigonometric relationship

$$sin ( α ) + sin ( β ) = 2 sin ( \frac{a + β}{2} ) cos ( \frac{a - β}{2} )$$

to Equation (36) results in Equation (37):

$${b}_{1} = \frac{2 {V}_{b u s}}{π} 2 sin ( \frac{π {D}_{-} + π {D}_{+}}{2} ) cos ( \frac{π {D}_{-} - π {D}_{+}}{2} ) \qquad ( 37 )$$

where α=πD₋, and β=πD₊.

Finally, substituting the firing angles of Equation (24) into Equation (37) gives Equation (38):

$$\begin{matrix}{b}_{1} = \frac{4 {V}_{bus}}{π} sin ( \frac{π {D}_{Σ}}{2} ) cos ( \frac{- π {D}_{Δ}}{2} ) \\ = \frac{4 {V}_{bus}}{π} sin ( \frac{π {D}_{Σ}}{2} ) cos ( \frac{π {D}_{Δ}}{2} )\end{matrix} \qquad ( 38 )$$

where cos(−θ)=cos(θ).

Since only the fundamental and dc harmonic of the modified square wave (Sₘ) are being matched to the reference voltage signal (V), Equation (25) can be simplified to Equation (39):

Sₘ=a₀+C₁ sin(θₛ−φ) (39)

In order to achieve the reference voltage signal (V) with the modified square wave (Sₘ), Equation (39) can be mapped to Equation (13) such that a₀=V₀, φ=0, and C₁=V_{ac}. V_{ac} is a reference AC amplitude given by Equation (40):

V_{ac}=\sqrt{(V_{d}²+V_{q}²)²} (40)

Because a₀=V₀, Equation (31) can be expressed as Equation (41):

$${D}_{Δ} = \frac{{V}_{0}}{{V}_{bus}} \qquad ( 41 )$$

Based on Equations (26) and (34), it follows that the ac magnitude C₁ equals the absolute value of the fundamental sine offset (b₁). Further, based on mapping Equations (39) and (13), the reference AC amplitude (V_{ac})=the fundamental sine offset (b₁). Furthermore, combining Equations (38) and (21) represents the reference AC amplitude (V_{ac}) by Equation (42):

$${V}_{a c} = \frac{4 {V}_{b u s}}{π} sin ( \frac{π {D}_{Σ}}{2} ) cos ( \frac{π {V}_{0}}{2 {V}_{b u s}} ) \qquad ( 42 )$$

Rearranging Equation (42) to define the sum duty cycle (D_{Σ}) gives Equation (43):

$${D}_{Σ} = \frac{2}{π} ( \frac{π {V}_{a c}}{4 {V}_{bus}} sec ( \frac{π {V}_{0}}{2 {V}_{bus}} ) ) \qquad ( 43 )$$

In addition, the set of firing angles (θ_{-ON}, θ_{-OFF}, θ_{+ON}, θ_{+OFF}) specified by Equation (24) are defined with respect to the phase angle (θₛ) of the reference voltage signal (V). To define the set of firing angles (θ_{-ON}, θ_{-OFF}, θ_{+ON}, θ_{+OFF}) with respect to the phase angle (θ) of the piston displacement, the firing angle calculation module 1210 can be configured to determine a phase shift φ_{c} for the phase angle (θₛ) of the reference voltage signal (V) based on the d-axis voltage component (V_{d}) and the q-axis voltage component (V_{q}). The phase shift may be represented by φ_{c}=atan 2(V_{d}, V_{q}), where atan 2(·,·) is the two-argument arctangent function defined as:

$$a tan 2 ( y , x ) = \{ \begin{matrix}arctan ( \frac{y}{x} ) & if x > 0 , \\ arctan ( \frac{y}{x} ) + π & if x < 0 and y \geq 0 , \\ arctan ( \frac{y}{x} ) - π & if x < 0 and y < 0 , \\ \frac{π}{2} & if x = 0 and y > 0 , \\ - \frac{π}{2} & if x = 0 and y < 0 , \\ undefined & if x = 0 and y = 0.\end{matrix}$$

Applying the trigonometric relationship

$$sin ( x ) = cos ( x - \frac{π}{2} )$$

to Equation (39) results in Equation (44):

$${V}_{s} = {V}_{0} + {V}_{ac} cos ( {θ}_{s} - \frac{π}{2} ) \qquad ( 44 )$$

Moreover, based on a linear combination of sine and cosine terms with equal arguments, Equation (13) can be expressed as Equation (45):

V=V₀+V_{ac} cos(θ−φ_{c}) (45)

Equating coefficients of Equations (44) and (45) results in Equation (46):

$${θ}_{s} = θ - {ϕ}_{c} + \frac{π}{2} \qquad ( 46 )$$

Hence, the firing angles calculated in Equation (24) can be incremented

$${ϕ}_{c} - \frac{π}{2}$$

to align the phase angle (θₛ) of the reference voltage signal (V) with the phase angle (θ) of the piston displacement. As such, the set of firing angles (θ_{-ON}, θ_{-OFF}, θ_{+ON}, θ_{+OFF}) can be defined with respect to the phase angle (θ) of the piston displacement according to Equation (47):

$$[ \begin{matrix}\begin{matrix}\begin{matrix}{θ}_{- ON} \\ {θ}_{- OFF}\end{matrix} \\ {θ}_{+ ON}\end{matrix} \\ {θ}_{+ OFF}\end{matrix} ] = [ \begin{matrix}\begin{matrix}\begin{matrix}\frac{3 π}{2} - π {D}_{-} + {ϕ}_{c} - \frac{π}{2} \\ \frac{3 π}{2} + π {D}_{-} + {ϕ}_{c} - \frac{π}{2}\end{matrix} \\ \frac{π}{2} - π {D}_{+} + {ϕ}_{c} - \frac{π}{2}\end{matrix} \\ \frac{π}{2} + π {D}_{+} + {ϕ}_{c} - \frac{π}{2}\end{matrix} ] = [ \begin{matrix}\begin{matrix}\begin{matrix}{ϕ}_{c} + π - π {D}_{-} \\ {ϕ}_{c} + π + π {D}_{-}\end{matrix} \\ {ϕ}_{c} - π {D}_{+}\end{matrix} \\ {ϕ}_{c} + π {D}_{+}\end{matrix} ] \qquad ( 47 )$$

Referring still to FIG. 12, the firing angle calculation module 1210 can be configured to determine the plurality of firing angles (θ_{-ON}, θ_{-OFF}, θ_{+ON}, θ_{+OFF}) based, at least in part, on the d-axis voltage component (V_{d}), the q-axis voltage component (V_{q}), the DC voltage component (V₀), and the DC bus voltage (V_{bus}). More particularly, the firing angle calculation module 1210 can receive the d-axis voltage component (V_{d}), the q-axis voltage component (Vg), the DC voltage component (V₀), and the DC bus voltage (V_{bus}). The firing angle calculation module 1210 can be configured to then determine the sum duty cycle (DE) and the difference duty cycle (D_{Δ}) by using Equations (41) and (43). Further, the firing angle calculation module 1210 can be configured to then determine the duty cycles (D₊), (D₋) by using Equations (22) and (23). Furthermore, the firing angle calculation module 1210 can be configured to determine the phase shift by φ_{c}=atan 2(V_{d}, V_{q}). In addition, the firing angle calculation module 1210 can be configured to then determine the plurality of firing angles (θ_{-ON}, θ_{-OFF}, θ_{+ON}, θ_{+OFF}) by using Equation (47).

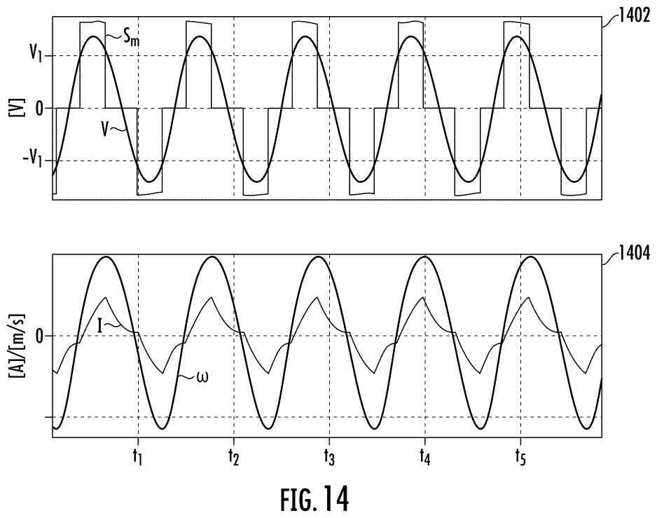

As an illustrative example, FIG. 14 provides correlated plots of testing results of the controller 1008 implementing the method 900 according to one or more exemplary embodiments of the present disclosure. Chart 1402 depicts the reference voltage signal (V) and the modified square wave (Sₘ) represented in volts (y-axis) over a period of time (x-axis). Furthermore, chart 1404 depicts measured current (I) of the motor represented in amperes (A) and piston velocity (ω) represented in meters per second (m/s) (y-axis) over the same period of time (x-axis) as that depicted in chart 1402.

The controller 1008 can operate the motor based on the modified square wave (Sₘ) to achieve the reference voltage signal (V). Controlling the motor based on the modified square wave (Sₘ) reduces the switching losses of the inverter 1010, as mentioned above. Further, as shown in charts 1402, 1404, implementing the modified square wave (Sₘ) not only achieves the reference voltage signal (V), but also produces motor current (I) that is in-phase with the piston velocity (ω). As such, the efficiency of the motor is improved by controlling the motor with the modified square wave (Sₘ) that results in reduced net losses of the linear compressor and operation the motor at the mechanical resonance.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for controlling a linear compressor of an appliance, the method comprising:
operating a motor of the linear compressor in order to drive a rotor of the motor;
obtaining, via a controller of the linear compressor, one or more voltage components of a voltage reference signal;
determining, via the controller, a modified square wave based, at least in part, on the one or more voltage components; and
controlling, via the controller, the motor based on the modified square wave.

2. The method of claim 1, wherein the one or more voltage components of the voltage reference signal comprise at least one of a d-axis voltage component, a q-axis voltage component, and a DC voltage component.

3. The method of claim 1, wherein the one or more voltage components are determined using a single-phase vector-like control scheme.

4. The method of claim 1, wherein determining the modified square wave based, at least in part, on the one or more voltage components further comprises:
determining a positive duty cycle and a negative duty cycle of the modified square wave based, at least in part, on the one or more voltage components; and
determining a plurality of firing angles based on the positive and negative duty cycles, the plurality of firing angles including a set of positive firing angles defining the positive duty cycle and a set of negative firing angles defining the negative duty cycle.

5. The method of claim 4, wherein controlling, via the controller, the motor based on the modified square wave further comprises:
determining a phase of the reference voltage signal;
providing a positive DC bus voltage to the motor when the phase of the reference voltage signal is in the set of positive firing angles; and
providing a negative DC bus voltage to the motor when the phase of the reference voltage signal is in the set of negative firing angles.

6. The method of claim 5, further comprising preventing, via the controller, voltage from being applied to the motor when the phase of the reference voltage signal is outside of the positive duty cycle and the negative duty cycle.

7. A linear compressor defining an axial direction and a vertical direction, the linear compressor for an appliance comprising:
a cylindrical casing defining a compressor chamber;
a piston positioned within the compressor chamber and being movable along the axial direction;
a motor operably coupled to the piston; and
an controller configured to supply a modified square wave to the motor, the controller configured to perform operations, the operations comprising:
obtaining one or more voltage components of a voltage reference signal;
determining a modified square wave based, at least in part, on the one or more voltage components; and
controlling the motor based on the modified square wave.

8. The linear compressor of claim 7, wherein the one or more voltage components of the voltage reference signal comprise at least one of a d-axis voltage component, a q-axis voltage component, and a DC voltage component.

9. The linear compressor of claim 7, wherein the one or more voltage components are determined using a single-phase vector-like control scheme.

10. The linear compressor of claim 7, wherein determining the modified square wave based, at least in part, on the one or more voltage components further comprises:
determining a positive duty cycle and a negative duty cycle of the modified square wave based, at least in part, on the one or more voltage components; and
determining a plurality of firing angles based on the positive and negative duty cycles, the plurality of firing angles including a set of positive firing angles defining the positive duty cycle and a set of negative firing angles defining the negative duty cycle.

11. The linear compressor of claim 10, wherein controlling the motor based on the modified square wave further comprises:
determining a phase of the reference voltage signal;
providing a positive DC bus voltage to the motor when the phase of the reference voltage signal is in the set of positive firing angles; and
providing a negative DC bus voltage to the motor when the phase of the reference voltage signal is in the set of negative firing angles.

12. The linear compressor of claim 11, wherein the operations further comprise:
preventing, via the controller, voltage from being applied to the motor when the phase of the reference voltage signal is outside of the positive duty cycle and the negative duty cycle.

13. The linear compressor of claim 7, wherein:
the piston is a reciprocating piston; and
the motor is a single-phase linear motor.

14. An appliance, comprising:
a cabinet defining an internal chamber;
a door mounted to the cabinet to provide selective access to the internal chamber;
a linear compressor, the linear compressor having a piston movable in a negative axial direction toward a compressor chamber and a positive axial direction away from the compressor chamber;
a motor operably coupled to the piston; and
a controller configured to supply a variable frequency waveform to the motor, the controller configured to perform operations, the operations comprising:
obtaining one or more voltage components of a voltage reference signal;
determining a modified square wave based, at least in part, on the one or more voltage components; and
controlling the motor based on the modified square wave.

15. The appliance of claim 14, wherein the one or more voltage components of the voltage reference signal comprise at least one of a d-axis voltage component, a q-axis voltage component, and a DC voltage component.

16. The appliance of claim 14, wherein the one or more voltage components are determined using a single-phase vector-like control scheme.

17. The appliance of claim 14, wherein determining the modified square wave based, at least in part, on the one or more voltage components further comprises:
determining a positive duty cycle and a negative duty cycle of the modified square wave based, at least in part, on the one or more voltage components; and
determining a plurality of firing angles based on the positive and negative duty cycles, the plurality of firing angles including a set of positive firing angles defining the positive duty cycle and a set of negative firing angles defining the negative duty cycle.

18. The appliance of claim 17, wherein controlling the motor based on the modified square wave further comprises:
determining a phase of the reference voltage signal;
providing a positive DC bus voltage to the motor when the phase of the reference voltage signal is in the set of positive firing angles; and
providing a negative DC bus voltage to the motor when the phase of the reference voltage signal is in the set of negative firing angles.

19. The appliance of claim 18, wherein the operations further comprise:
preventing, via the controller, voltage from being applied to the motor when the phase of the reference voltage signal is outside of the positive duty cycle and the negative duty cycle.

20. The appliance of claim 14, wherein:
the piston is a reciprocating piston; and
the motor is a single-phase linear motor.
